(19) United States
(12) Patent Application Publication
(10) Pub. No.: US 2019/0352012 A1
(43) Pub. Date: Nov. 21, 2019

(54) AIRCRAFT VENTILATION SYSTEM

(71) Applicant: THE BOEING COMPANY, CHICAGO, IL (US)

(72) Inventor: Fue Chue Vue, Mill Creek, WA (US)

(73) Assignee: THE BOEING COMPANY, CHICAGO, IL (US)

(21) Appl. No.: 16/527,089

(22) Filed: Jul. 31, 2019

Related U.S. Application Data
(63) Continuation of application No. 14/505,838, filed on Oct. 3, 2014.

(51) Int. Cl. B64D 13/00

(52) U.S. Cl. CPC B64D 13/00; B64D 2013/0655

(57) ABSTRACT

An air distribution system for use in an aircraft includes a main distribution duct configured to receive mixed air and a gasper distribution duct coupled in flow communication with the main distribution duct. The gasper distribution duct is configured to receive a portion of the mixed air from the main distribution duct. The system also includes a plurality of gasper outlets in flow communication with the gasper distribution duct. The plurality of gasper outlets includes a subset of gasper outlets located within a same region of the aircraft. The system also includes a heater in flow communication between the gasper distribution duct and the subset of gasper outlets. The heater is configured to heat the mixed air flowing from the gasper distribution duct to the subset of gasper outlets.

### RELATED APPLICATIONS

This application is a continuation of U.S. patent application Ser. No. 14/505,838, entitled “Aircraft Ventilation System,” filed Oct. 3, 2014, which is hereby incorporated by reference in its entirety.

### BACKGROUND

The implementations described herein relate generally to an aircraft ventilation system having a plurality of outlets, and, more specifically, to an aircraft ventilation system that is capable of providing heat to only a portion of the outlets.

During flights, especially long-haul flights, crew work areas of the cabin can become uncomfortably cold for the crew working and resting there. At least some known aircraft ventilation systems, or environmental control systems (ECSs), include a supply duct and air outlets (also known as gasper outlets) in flow communication with the supply duct. The supply duct supplies mixed air (a combination of fresh air and recirculated cabin air) to the aircraft cabin, and the gasper outlets can be used to selectively supply additional mixed air to the cabin at an associated location. Two or more gasper outlets can join at a common duct before joining to the supply duct, or a single gasper outlet can directly connect to the supply duct. The configuration of the gasper outlet ducting is based on optimized duct routing relative to the space available for the ducting in the aircraft.

In conventional ECSs, outside air is brought into the air conditioning packs (AC packs) from the engine bleed air system. The AC packs cool the outside air and transport the air to the air distribution system. The outside air is typically mixed with recirculated air from the passenger cabin and is usually maintained above freezing but not usually over 40 degrees Fahrenheit (° F.) (4.4 degrees Celsius (° C.)). As such, warm air from the main engines (also known as trim air) is mixed with the mixed air to raise the temperature to between 50° F. (10.0° C.) and 60° F. (15.6° C.). This trimmed, mixed air is supplied to the cabin of the aircraft from the AC packs via the supply duct and ECS outlets located throughout the passenger cabin. If a crew member or passenger would like additional mixed air, the individual can open the gasper outlet associated with his seat to allow the trimmed, mixed air to flow out of the supply duct and through the gasper. The mixed air also usually between 50° F. (10.0° C.) and 60° F. (15.6° C.) and is sufficient to meet temperature requirements in the passenger portion of the cabin because of the heat loads present in the passenger portion, such as people and aircraft components that discharge heat.

However, in less populated portions of the cabin, such as the galley and other crew areas, the mixed air can overly cool that region of the cabin. The refrigeration of galley carts in galley areas can add to the over-cooling issue. Heavy body structure associated with entry/exit doors can also add to the over-cooling issue. Gasper outlets are provided at the jump seats provided for crew seating in the galley areas and other crew areas. These gasper outlets provide additional cooling air to the person sitting in the associated jump seat similarly to the outlets at the passenger seats. Further, some known galleys include additional gasper outlets provided at workstations in the galley for the comfort of the crew working there. Additional ventilation may not be easily supplied to galley areas because of the interior architecture, space/weight restrictions, and/or coordination with in-house units and outside suppliers.

Some known galleys include supplemental heating systems, such as heated floor panels or heated air outlets proximate the aircraft door, that provide heat to the galley. However, these systems may not provide sufficient heat because of space and operational restrictions. Furthermore, such systems increase the weight of the aircraft and are expensive to implement and install because of the coordination required between an in-house manufacturer and an outside supplier. Additionally, such systems are conventionally installed only on newly manufactured aircraft because retrofitting an existing aircraft is expensive and takes the aircraft out of service for an extended period.

### BRIEF DESCRIPTION

In one aspect, an air distribution system for use in an aircraft is provided. The air distribution system includes a main distribution duct configured to receive mixed air and a gasper distribution duct coupled in flow communication with the main distribution duct. The gasper distribution duct is configured to receive a portion of the mixed air from the main distribution duct. The system also includes a plurality of gasper outlets in flow communication with the gasper distribution duct. The plurality of gasper outlets includes a subset of gasper outlets located within a same region of the aircraft. The system also includes a heater in flow communication between the gasper distribution duct and the subset of gasper outlets. The heater is configured to heat the mixed air flowing from the gasper distribution duct to the subset of gasper outlets.

In another aspect, a method of supplying heated air to a portion of an aircraft is provided. The method includes channeling mixed air through a main distribution duct and channeling a portion of the mixed air through a gasper distribution duct that is coupled in flow communication with the main distribution duct. A portion of mixed air is then channeled through a subset of gasper outlets of a plurality of gasper outlets that are in flow communication with the gasper distribution duct. The subset of gasper outlets are located in a same region of the aircraft. The method also includes channeling the portion of the mixed air through a heater that is coupled in flow communication between the gasper distribution duct and the subset of gasper outlets. The heater is configured to heat the mixed air flowing from the gasper distribution duct to the subset of gasper outlets.

In yet another aspect, a galley air distribution system for providing heated air to a galley region of an aircraft is provided. The system includes a plurality of gasper outlets located in the galley region and a gasper distribution duct coupled in flow communication with said plurality of gaspers. The gasper distribution duct is configured to receive mixed air. The system also includes a heater coupled in flow communication between the gasper distribution duct and the plurality of gasper outlets. The heater is configured to heat the mixed air flowing from the gasper distribution duct to the gasper outlets.

### BRIEF DESCRIPTION OF THE DRAWINGS

FIG. 1 is a flow diagram of an exemplary aircraft production and service methodology;

FIG. 2 is a block diagram of an exemplary aircraft.

FIG. 3 is a simplified view of an aircraft illustrating a cabin area, a cargo compartment, and an exemplary air conditioning system;

FIG. 4 is a schematic diagram of an exemplary main air distribution system including an exemplary galley air distribution system; and

FIG. 5 is a schematic flow diagram of a method of supplying heated air to a portion of the aircraft shown in FIG. 3.

### DETAILED DESCRIPTION

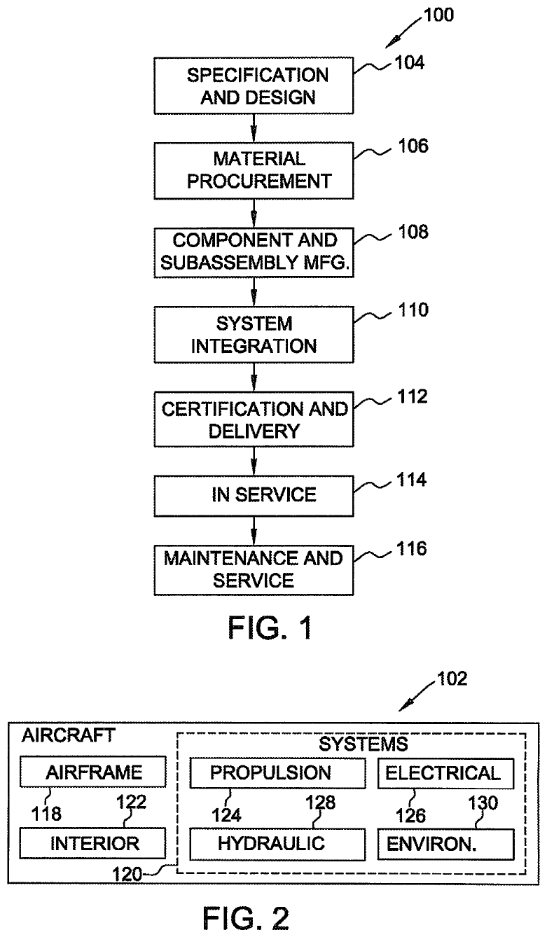

Referring FIG. 1, implementations of the disclosure may be described in the context of an aircraft manufacturing and service method 100 and via an aircraft 102 (shown in FIG. 2). During pre-production, including specification and design 104 data of aircraft 102 may be used during the manufacturing process and other materials associated with the airframe may be procured 106. During production, component and subassembly manufacturing 108 and system integration 110 of aircraft 102 occurs, prior to aircraft 102 entering its certification and delivery process 112. Upon successful satisfaction and completion of airframe certification, aircraft 102 may be placed in service 114. While in service by a customer, aircraft 102 is scheduled for periodic, routine, and scheduled maintenance and service 116, including any modification, reconfiguration, and/or refurbishment, for example. In alternative implementations, manufacturing and service method 100 may be implemented via vehicles other than an aircraft.

Each portion and process associated with aircraft manufacturing and/or service 100 may be performed or completed by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 2, aircraft 102 produced via method 100 may include an airframe 118 having a plurality of systems 120 and an interior 122. Examples of high-level systems 120 include one or more of a propulsion system 124, an electrical system 126, a hydraulic system 128, and/or an environmental system 130. Any number of other systems may be included.

Apparatus and methods embodied herein may be employed during any one or more of the stages of method 100. For example, components or subassemblies corresponding to component production process 108 may be fabricated or manufactured in a manner similar to components or subassemblies produced while aircraft 102 is in service. Also, one or more apparatus implementations, method implementations, or a combination thereof may be utilized during the production stages 108 and 110, for example, by substantially expediting assembly of, and/or reducing the cost of assembly of aircraft 102. Similarly, one or more of apparatus implementations, method implementations, or a combination thereof may be utilized while aircraft 102 is being serviced or maintained, for example, during scheduled maintenance and service 116.

As used herein, the term “aircraft” may include, but is not limited to, airplanes, unmanned aerial vehicles (UAVs), gliders, helicopters, and/or any other object that travels through airspace. Further, in an alternative implementation, the aircraft manufacturing and service method described herein may be used in any manufacturing and/or service operation. Moreover, as used herein, the term “gasper” or “gasper nozzle” is meant to describe an airflow nozzle that may be found within an interior portion of a vehicle, such as, but not limited to, automobiles, trains, ships, aircraft, or any other type of conveyance.

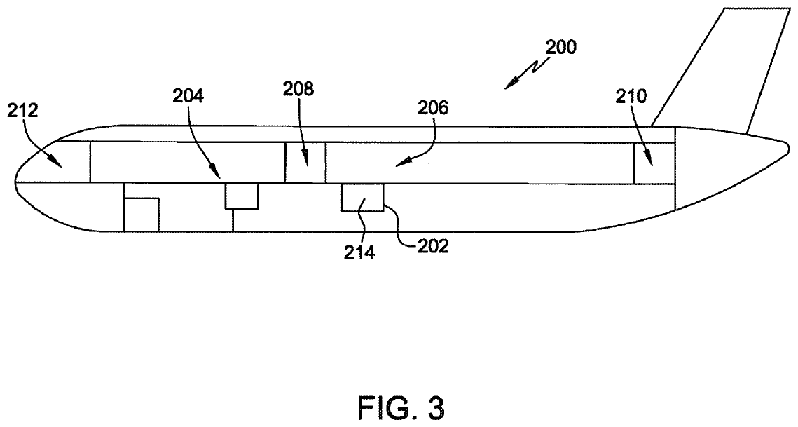

Referring to FIG. 3, there is shown a mobile platform or aircraft 200 that includes an exemplary air distribution system 202. In the exemplary implementation, mobile platform 200 is a commercial passenger jet aircraft. Although the context of the discussion contained herein is with respect to a commercial jet passenger aircraft, it should be understood that the teachings of the present disclosure are compatible with all types of aircraft including, but not limited to, private propeller driven aircraft, private jets, commercial propeller driven passenger aircraft, cargo aircraft, military aircraft, and the like. Furthermore, although air distribution system 202 disclosed herein is described as being compatible for use on board an aircraft, it should be understood that air distribution system 202 is compatible with all types of vehicles. For example, and without limitation, air distribution system 202 may be implemented on board automobiles, buses, trains, ships, spacecraft, and any other type of conveyance. Additionally, air distribution system 202 is not limited to implementation on vehicles, but may also be compatible for use in tents, houses, buildings, stadiums, theaters, and other permanent and/or semi-permanent structures.

Aircraft 200 includes various pressurized areas that require a constant influx of air for passenger and crew comfort. In the exemplary implementation, such areas include, but are not limited to, a first passenger cabin 204, a second passenger cabin 206, a galley area 208, a crew rest area 210, and a cockpit area 212. Alternatively, aircraft 200 includes any number of passenger cabins and galleys and is not limited to the number shown in FIG. 3. Aircraft 200 also includes a mix bay 214 that is sized to house at least a portion of air distribution system 202.

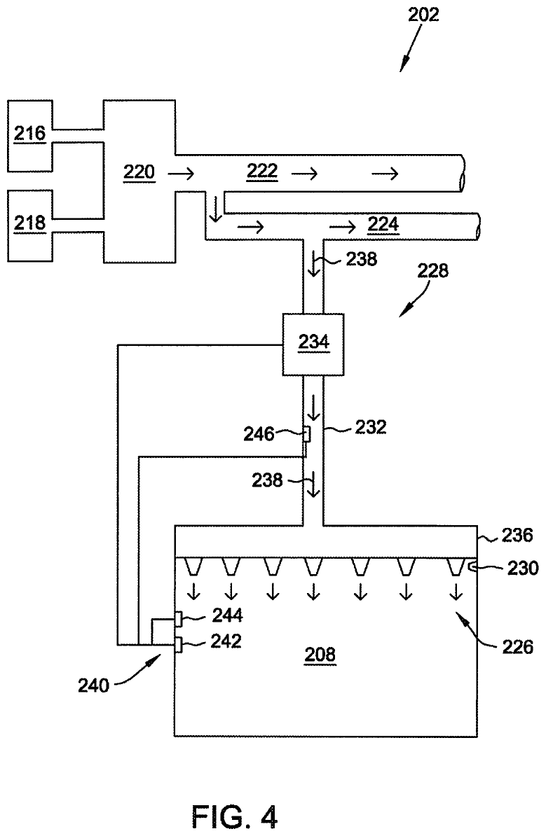

FIG. 4 is a schematic diagram of air distribution system 202 that may be used on aircraft 200 (shown in FIG. 3). In the exemplary implementation, air distribution system 202 includes at least one air pack 216 and a recirculation system 218 that each supply air to a mix manifold 220 located in mix bay 214 (shown in FIG. 3). Outside air, that is, air that has not yet been channeled at least once through areas 204, 206, 208, 210, and 212 is drawn into air distribution system 202 by air pack 216. The outside air is drawn from at least one of outside aircraft 200, a compressor of an engine, and an auxiliary power unit. Air pack 216 performs a variety of functions, such as compressing the relatively thin air drawn from outside aircraft 200, heating or cooling the air, and pumping it through air distribution system 202. Preferably, air distribution system 202 includes multiple air packs 216, including left and right packs located on opposite sides of aircraft 200. Recirculation system 218 draws air from the pressurized areas of aircraft 200, such as passenger cabins 204 and 206, galley 208, crew rest 210, and cockpit area 212 and channels the recirculated air to mix manifold 220 for mixing with the conditioned outside air from air pack 216.

Mix manifold 220 is configured to remove entrained moisture, such as ice particles or water droplets, from the air mixture to prevent ice from propagating into areas 204, 206, 208, 210, and 212. More specifically, mix manifold 220 mixes outside air from air pack 216 with recirculated air from recirculation system 218 to form a resultant air flow mixture having a temperature that is at or above freezing. More specifically, any ice particles suspended in the mixed air making it past the mix manifold 220 are melted and condensed into droplets when trim air is injected into the mixed air. Any condensed water droplets are then collected in downstream ducting prior to distribution of air into the cabin. Once mix manifold 220 has properly mixed the outside and recirculated air, the mixed air is channeled to a main distribution duct 222 of air distribution system 202.

Main distribution duct 222 is configured to channel the mixed air to any system of aircraft 200 that requires air for normal operation. More specifically, main distribution duct 222 channels air to a plurality of main air outlets (not shown) located in passenger cabins 204 and 206. The air exiting from these outlets is delivered to provide air to the passengers and crew within aircraft 200. As described above, the air channeled from the main outlets is between 50° F. (10.0° C.) and 60° F. (15.6° C.), and additional heat is provided to passenger areas by the body heat of the passengers themselves and by heat from operational components of aircraft 200. Therefore, passenger cabins 204 and 206 may not require additional heated air to maintain the comfort of the passengers.

However, some passengers may desire an additional amount of mixed air for maximum comfort. Therefore, main air distribution system 202 further includes a gasper distribution duct 224 that is coupled in flow communication with a plurality of gasper outlets 226 to provide additional mixed air. Each gasper outlet 226 is associated with an individual seat in passenger cabins 204 and 206, galley 208, crew rest 210, and cockpit area 212. In the exemplary implementation, gasper distribution duct 224 is coupled in flow communication with and branches off from main distribution duct 222 such that gasper distribution duct 224 receives a portion of the air supplied to main distribution duct 222 from mix manifold 220. Alternatively, gasper distribution duct is in direct flow communication with one of air pack 216 or recirculation system 218 such that gasper distribution duct 224 receives only outside air from air pack 216 or recirculated air from recirculation system 218. In certain areas of aircraft 200, such as galley area 208, gasper outlets 226 serve as the primary ventilation mechanism due to space and operation restrictions that prevent galley 208 from having the main air outlets described above. Furthermore, galley area 208 and crew rest area 210 are not as heavily populated as passenger cabins 204 and 206, and also include other components that may result in areas 208 and 210 being uncomfortably cool for the crew, as described above.

Therefore, in the exemplary implementation, main air distribution system 202 includes a galley air distribution system 228 that provides heated air to at least galley area 208 of aircraft 200 for the comfort of the crew stationed therein. Although galley air distribution system 228 is described herein as supplying heated air to galley area 208, galley air distribution system 228 may supply heated air to any portion of aircraft 200, such as, but not limited to, passenger cabins 204 and 206, crew rest area 210, and cockpit 212.

In the exemplary implementation, galley air distribution system 228 includes gasper distribution duct 224, a subset 230 of the plurality of gasper outlets 226, a subset supply duct 232, an in-line heater 234, and a subset manifold 236. As air enters gasper distribution duct 224, it flows in a direction represented by arrows 238 such that subset supply duct 232, heater 234, subset manifold 236, and subset 230 are coupled in serial flow arrangement. More specifically, subset supply duct 232 is coupled in flow communication between gasper distribution duct 224 and subset manifold 236 having subset 230 of gasper outlets 226. Moreover, subset manifold 236 is coupled in flow communication between subset supply duct 232 and subset 230 of gasper outlets 226. Subset 230 represents a group of gasper outlets 226 that are all located within a same region of aircraft 200. More specifically, in the exemplary implementation, subset 230 represents gasper outlets 226 located in galley area 208. Alternatively, subset 230 represents a grouping of gasper outlets 226 located in any of passenger cabins 204 and 206, crew rest 210, and cockpit 212.

Heater 234 is coupled along subset supply duct 232 and is also in flow communication between gasper distribution duct 224 and subset manifold 236 having subset 230 of gasper outlets 226. In the exemplary implementation, heater 234 is configured to heat the air flowing from gasper distribution duct 224 to subset 230 of gasper outlets 226, that is, the air flowing through subset supply duct 232, such that heater 234 facilitates an efficient thermal transfer from heater 234 to the passing air without excessively impeding air movement. In one implementation, heater 234 is coupled to a supplemental heating system (not shown) in aircraft 200 to provide power to heater 234. Heater 234 is configured to heat the air as it flows through subset supply duct 232 such that as the air is discharged through each gasper outlet 226 of subset 230, warm air is provided to galley area 208.

In the exemplary implementation, galley air distribution system 228 also includes a temperature control system 240 that enables crew members to control heater 234 to control the temperature of the air flowing from subset 230. Control system 240 includes a controller 242 that is operatively coupled to heater 234 and is configured to control the temperature of the air that is channeled from heater 234 to subset 230 of gasper outlets 226. Control system 240 also includes a compartment temperature sensor 244 and a duct temperature sensor 246 that are both operatively coupled to controller 242. In the exemplary implementation, sensors 244 and 246 are suitably a standard temperature sensor, such as a thermocouple or thermistor. Compartment sensor 244 is located in galley area 208 to sense the ambient temperature therein, and duct temperature sensor 246 is located in subset supply duct 232 to sense the ambient temperature therein. Alternatively, sensors 244 and 246 may be located as desired, provided that sensors 244 and 246 are located downstream from heater 234 to ensure that heater 234 elevates the air to the proper temperature.

In one implementation, control system 240 is an open-loop control system where a crew member uses controller 242 to select either a specific temperature or an operating level setting, such as low, medium, or high, and heater 234 then supplies air according to the predetermined temperature or operating level setting until a different temperature or operating level setting is selected.

In another implementation, control system 240 is a closed loop system where a crew member uses controller 242 to select a desired predetermined temperature. Sensor 244 then senses the actual temperature of the air and relays the sensed temperature to controller 242. Controller 242 is configured to compare the sensed temperature from sensor 244 to the predetermined selected temperature indicated by the crew member and control heater 234 to provide additional heat or less heat to the air based on the comparison. Furthermore, sensor 246 senses the temperature within supply duct 232 and provides an additional control feedback to controller 242.

Controller 242 is configured to control heater 234 to provide heated air to galley area 208 in order to maintain an air temperature in galley area 208 above approximately 60° F. (15.6° C.). Preferably, controller 242 is programmed to maintain the air temperature in a range of between approximately 65° F. (18.3° C.) and approximately 75° F. (23.9° C.). Furthermore, in one embodiment, heater 234 of galley air distribution system 228 is operable only when aircraft 200 is in flight. That is, when aircraft 200 is grounded, heater 234 is non-operable such that mixed air from gasper distribution duct 224 does not require heating to maintain galley area 208 at a comfortable temperature. Alternatively, heater 234 is operational whether aircraft 200 is in flight or grounded. Therefore, galley air distribution system 228 facilitates providing warm air or cool air through subset 230 of gasper outlets 226, rather than only supplying cool air.

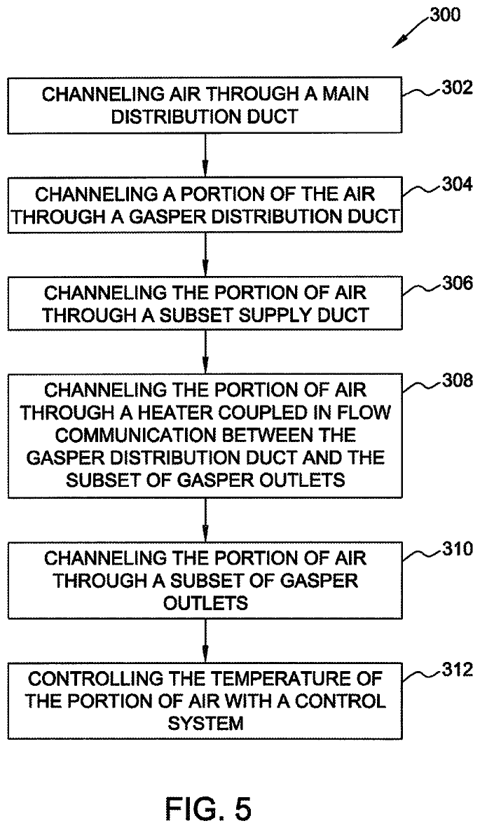

FIG. 5 is a schematic flow diagram of a method 300 of supplying heated air to a portion of aircraft 200 (shown in FIG. 3). Method 300 includes channeling 302 mixed air through a main distribution duct, such as main distribution duct 222 (shown in FIG. 4). A portion of the mixed air is then channeled 304 through a gasper distribution duct, such as gasper distribution duct 224 (shown in FIG. 4). As described above, the gasper distribution duct is coupled in flow communication with the main distribution duct.

Method 300 also includes channeling 306 the portion of mixed air through a subset supply duct, such as subset supply duct 232 (shown in FIG. 4). The subset supply duct is coupled in flow communication with the gasper distribution duct. A heater, such as heater 234 (shown in FIG. 4), is coupled along the subset supply duct, downstream of the gasper distribution duct, such that as air is channeled 306 through subset supply duct, the air is also channeled 308 through the heater. As described above, the heater is configured to heat the mixed air flowing from the gasper distribution duct to a subset of gasper outlets, such as subset 230 of gasper outlets 226 (shown in FIG. 4). The heated air is then channeled 310 though the subset of gasper outlets that are coupled in flow communication with the gasper distribution duct. As described above, the subset of gasper outlets are located in a same region of the aircraft. More specifically, the subset of gasper outlets are located in a galley region, such as galley area 208 (shown in FIG. 4), of the aircraft.

Method 300 further includes controlling 312 a temperature of the portion of the mixed air channeled from the heater through the subset of gasper outlets with a control system, such as control system 240 (shown in FIG. 4). The control system includes a controller, such as controller 242 (shown in FIG. 4), that is operatively coupled to the heater. In the exemplary implementation, controlling 312 the temperature of the air includes sensing a temperature of the air within the galley using a sensor, such as sensor 244 (shown in FIG. 4), and adjusting the heater using the controller based on a comparison of the sensed temperature and a predetermined temperature as indicated by a crew member on the controller. In another implementation, controlling 312 the temperature of the air includes controlling the heater to discharge air at a temperature or operational level setting, as indicated by a crew member, until a different temperature or operating level setting is selected.

The implementations described herein facilitate providing a specific area of an aircraft, namely the galley area, with heated air to maximize the comfort of the crew. The galley air distribution system described herein selectively channels warm or cool air therethrough to the galley area, rather than supplying only cooling air to the same. More specifically, the galley air distribution system channels air through an in-line heater that warms the air such that when the air is discharged through a subset of gasper outlets, the air is relatively warmer than the air discharged through other gasper outlet not within the subset, such as those within the passenger cabin areas. The subset of gasper outlets are coupled together via a subset manifold that enables a single heater to provide warm air to the entire subset of gasper outlets. As such, the additional costs, weight, and complexity associated with having an individual heater for each gasper outlet is avoided. Additionally, the gasper distribution system described herein may be retrofit onto existing aircraft or be incorporated onto newly manufactured aircraft.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An air distribution system for an aircraft, the air distribution system comprising:
a main distribution duct configured to receive mixed air and channel a first portion of the mixed air to one or more passenger cabins of the aircraft;
a gasper distribution duct in fluid communication with the main distribution duct, wherein the gasper distribution duct receives a second portion of the mixed air from the main distribution duct;
a subset supply duct in fluid communication with the gasper distribution duct, wherein the subset supply duct receives at least a portion of the second portion of the mixed air from the gasper distribution duct;
a heater disposed in the subset supply duct, wherein the heater is configured to heat the at least a portion of the second portion of the mixed air; and
a first plurality of gasper outlets in fluid communication with the subset supply duct, wherein the first plurality of gasper outlets are within one or more galleys or one or more crew rest areas of the aircraft, and wherein the first plurality of gasper outlets are configured to receive the at least a portion of the second portion of the mixed air that is heated by the heater.

2. The air distribution system of claim 1, further comprising:
at least one air pack configured to draw outside air from outside the aircraft into the air distribution system;
a recirculation system configured to draw recirculated air from pressurized areas of the aircraft into the air distribution system; and
a mix manifold in fluid communication with the at least one air pack, the recirculation system, and the main distribution duct, wherein the mix manifold is configured to mix the outside air from the at least one air pack with the recirculated air from the recirculation system to form the mixed air, and provide the mixed air to the main distribution duct.

3. The air distribution system of claim 2, wherein the pressurized areas of the aircraft comprise the one or more passenger cabins, the one or more galleys, the one or more crew rest areas, and a cockpit area.

4. The air distribution system of claim 1, wherein trim air from one or more engines of the aircraft is injected into the mixed air.

5. The air distribution system of claim 1, further comprising a second plurality of gasper outlets in fluid communication with the gasper distribution duct upstream from the heater, wherein each of the second plurality of gasper outlets is associated within an individual seat within the one or more passenger cabins.

6. The air distribution system of claim 1, further comprising a subset manifold in fluid communication with the subset supply duct and the first plurality of gasper outlets.

7. The air distribution system of claim 6, wherein the gasper distribution duct, the subset supply duct, the heater, the subset manifold, and the first plurality of gasper outlets are in serial flow arrangement.

8. The air distribution system of claim 1, further comprising a temperature control system that is configured to control a temperature of the at least a portion of the second portion of the mixed air.

9. The air distribution system of claim 8, wherein the temperature control system comprises:
a controller operatively coupled to the heater, wherein the controller is configured to control the heater;
a compartment temperature sensor operatively coupled to the controller, wherein the compartment temperature sensor is disposed within the one or more galley areas or the one or more crew rest areas and is configured to sense a first temperature within the one or more galley areas or the one or more crew rest areas; and
a duct temperature sensor operatively coupled to the controller, wherein the duct temperature sensor is disposed within the subset supply duct downstream from the heater, and wherein the duct temperature sensor is configured to sense a second temperature within the subset supply duct.

10. An air distribution method for an aircraft, the air distribution method comprising:
receiving mixed air at a main distribution duct;
channeling a first portion of the mixed air through the main distribution duct to one or more passenger cabins of the aircraft;
receiving, by a gasper distribution duct in fluid communication with the main distribution duct, a second portion of the mixed air from the main distribution duct;
receiving, by a subset supply duct in fluid communication with the gasper distribution duct, at least a portion of the second portion of the mixed air from the gasper distribution duct;
heating, by a heater disposed in the subset supply duct, the at least a portion of the second portion of the mixed air;
receiving, by a first plurality of gasper outlets within one or more galleys or one or more crew rest areas of the aircraft, the at least a portion of the second portion of the mixed air that is heated by the heater.

11. The air distribution method of claim 10, further comprising:
drawing, by at least one air pack, outside air from outside the aircraft into the air distribution system;
drawing, by a recirculation system, recirculated air from pressurized areas of the aircraft into the air distribution system;
mixing, by a mix manifold in fluid communication with the at least one air pack, the recirculation system, and the main distribution duct, the outside air from the at least one air pack with the recirculated air from the recirculation system to form the mixed air; and
providing, from the mix manifold, the mixed air to the main distribution duct.

12. The air distribution method of claim 11, wherein the pressurized areas of the aircraft comprise the one or more passenger cabins, the one or more galleys, the one or more crew rest areas, and a cockpit area.

13. The air distribution method of claim 10, further comprising injecting trim air from one or more engines of the aircraft into the mixed air.

14. The air distribution method of claim 10, further comprising fluidly coupling a second plurality of gasper outlets with the gasper distribution duct upstream from the heater, wherein each of the second plurality of gasper outlets is associated within an individual seat within the one or more passenger cabins.

15. The air distribution method of claim 10, further comprising fluidly coupling a subset manifold with the subset supply duct and the first plurality of gasper outlets.

16. The air distribution method of claim 15, further comprising arranging the gasper distribution duct, the subset supply duct, the heater, the subset manifold, and the first plurality of gasper outlets in serial flow.

17. The air distribution method of claim 10, further comprising controlling, by a temperature control system, a temperature of the at least a portion of the second portion of the mixed air.

18. The air distribution method of claim 17, wherein said controlling comprises:
controlling the heater by a controller operatively coupled the heater;
disposing a compartment temperature sensor operatively coupled to the controller within the one or more galley areas or the one or more crew rest areas;
sensing, by the compartment temperature sensor, a first temperature within the one or more galley areas or the one or more crew rest areas;
disposing a duct temperature sensor operatively coupled to the controller within the subset supply duct downstream from the heater; and
sensing, by the duct temperature sensor, a second temperature within the subset supply duct.

19. An air distribution system for an aircraft, the air distribution system comprising:
a main distribution duct configured to receive mixed air and channel a first portion of the mixed air to one or more passenger cabins of the aircraft;
a gasper distribution duct in fluid communication with the main distribution duct, wherein the gasper distribution duct receives a second portion of the mixed air from the main distribution duct;
a subset supply duct in fluid communication with the gasper distribution duct, wherein the subset supply duct receives at least a portion of the second portion of the mixed air from the gasper distribution duct;
a heater disposed in the subset supply duct, wherein the heater is configured to heat the at least a portion of the second portion of the mixed air;
a first plurality of gasper outlets in fluid communication with the subset supply duct, wherein the first plurality of gasper outlets are within one or more galleys or one or more crew rest areas of the aircraft, and wherein the first plurality of gasper outlets are configured to receive the at least a portion of the second portion of the mixed air that is heated by the heater;
a subset manifold in fluid communication with the subset supply duct and the first plurality of gasper outlets, wherein the gasper distribution duct, the subset supply duct, the heater, the subset manifold, and the first plurality of gasper outlets are in serial flow arrangement;
a second plurality of gasper outlets in fluid communication with the gasper distribution duct upstream from the heater, wherein each of the second plurality of gasper outlets is associated within an individual seat within the one or more passenger cabins; and
a temperature control system that is configured to control a temperature of the at least a portion of the second portion of the mixed air, wherein the temperature control system comprises:
a controller operatively coupled to the heater, wherein the controller is configured to control the heater;
a compartment temperature sensor operatively coupled to the controller, wherein the compartment temperature sensor is disposed within the one or more galley areas or the one or more crew rest areas and is configured to sense a first temperature within the one or more galley areas or the one or more crew rest areas; and
a duct temperature sensor operatively coupled to the controller, wherein the duct temperature sensor is disposed within the subset supply duct downstream from the heater, and wherein the duct temperature sensor is configured to sense a second temperature within the subset supply duct.

20. The air distribution system of claim 19, further comprising:
at least one air pack configured to draw outside air from outside the aircraft into the air distribution system;
a recirculation system configured to draw recirculated air from pressurized areas of the aircraft into the air distribution system; and
a mix manifold in fluid communication with the at least one air pack, the recirculation system, and the main distribution duct, wherein the mix manifold is configured to mix the outside air from the at least one air pack with the recirculated air from the recirculation system to form the mixed air, and provide the mixed air to the main distribution duct,
wherein the pressurized areas of the aircraft comprise the one or more passenger cabins, the one or more galleys, the one or more crew rest areas, and a cockpit area, and
wherein trim air from one or more engines of the aircraft is injected into the mixed air.
